(19) United States
(12) Patent Application Publication
(10) Pub. No.: US 2025/0189708 A1
(43) Pub. Date: Jun. 12, 2025

(54) OPTICAL FILTER

(71) Applicant: AGC Inc., Tokyo (JP)

(72) Inventors: Takahiro SAKAGAMI, Shizuoka (JP); Takashi NAGATA, Shizuoka (JP); Kazuhiko SHIONO, Fukushima (JP); Yuichiro ORITA, Fukushima (JP)

(73) Assignee: AGC Inc., Tokyo (JP)

(21) Appl. No.: 19/059,856

(22) Filed: Feb. 21, 2025

Related U.S. Application Data
(63) Continuation of application No. PCT/JP2023/030945, filed on Aug. 28, 2023.

(30) Foreign Application Priority Data
Aug. 31, 2022 (JP) 2022-138364

(51) Int. Cl. G02B 5/22

(52) U.S. Cl. CPC G02B 5/22

(57) ABSTRACT

An optical filter includes a dielectric multilayer film 1, a resin film, a phosphate glass, and a dielectric multilayer film 2 in this order. The resin film includes a resin and a near-infrared ray absorbing dye having a maximum absorption wavelength in 690 nm to 800 nm in the resin, the resin film has a thickness of 10 μm or less, and the optical filter satisfies all of the spectral characteristics (i-1) to (i-8).

### CROSS-REFERENCE TO RELATED APPLICATIONS

This is a bypass continuation of International Application No. PCT/JP2023/030945 filed on Aug. 28, 2023, and claims priority from Japanese Patent Application No. 2022-138364 filed on Aug. 31, 2022, the entire content of which is incorporated herein by reference.

### TECHNICAL FIELD

The present invention relates to an optical filter that transmits visible light and shields near-infrared light.

### BACKGROUND ART

In an imaging device including a solid state image sensor, in order to satisfactorily reproduce a color tone and obtain a clear image, an optical filter that transmits light in a visible region (hereinafter, also referred to as “visible light”) and shields light in a near-infrared wavelength region (hereinafter, also referred to as “near-infrared light”) is used.

Examples of such an optical filter include various types such as a reflection type filter in which dielectric thin films having different refractive indices are alternately laminated on one surface or both surfaces of a transparent substrate (dielectric multilayer film) and light to be shielded is reflected by utilizing interference of light.

Patent Literatures 1 and 2 disclose an optical filter including a dielectric multilayer film and an absorbing layer containing a dye.

### CITATION LIST

### Patent Literature

Patent Literature 1: WO2014/002864
Patent Literature 2: WO2018/043564

### SUMMARY OF INVENTION

### Technical Problem

In an optical filter in the related art utilizing reflection of a dielectric multilayer film, since an optical thickness of the dielectric multilayer film changes depending on an incident angle of light, there is a problem that a spectral transmittance curve and a spectral reflectance curve change depending on the incident angle. For example, according to the number of laminated layers of the multilayer film, a large change in transmittance in a visible light region due to interference caused by reflected light at interfaces of respective layers, that is, a ripple is generated, and the larger the incident angle of light is, the stronger the generation of the ripple is. This causes a problem that a captured amount of light in a visible light region changes at a high incident angle and image reproducibility is reduced. In particular, with a reduction in height of camera modules in recent years, use under a condition of a high incident angle is assumed, and therefore an optical filter that is hardly affected by an incident angle is required.

An object of the present invention is to provide an optical filter in which a ripple in a visible light region is prevented even with incident light having a high incident angle, and a transmittance in the visible light region and shielding properties in a near-infrared light region are excellent.

### Solution to Problem

The present invention provides an optical filter having the following configuration.
[1] An optical filter including a dielectric multilayer film 1, a resin film, phosphate glass, and a dielectric multilayer film 2 in this order, in which
the resin film includes a resin and a near-infrared ray absorbing dye having a maximum absorption wavelength in 690 nm to 800 nm in the resin,
the resin film has a thickness of 10 μm or less, and
the optical filter satisfies all of the following spectral characteristics (i-1) to (i-8).
(i-1) An average transmittance T_{450-600(0deg)AVE} at a wavelength of 450 nm to 600 nm and an incident angle of 0 degrees is 88.5% or more.
(i-2) An absolute value of a difference between an average transmittance T_{450-600(0deg)AVE} and an average transmittance T_{450-600(60deg)AVE} at a wavelength of 450 nm to 600 nm and an incident angle of 60 degrees is 6% or less.
(i-3) In a wavelength of 450 nm to 600 nm, an absolute value of a difference between a transmittance at an incident angle of 0 degrees and a transmittance at an incident angle of 60 degrees is 8% or less at maximum.
(i-4) An average transmittance T_{600-700(0deg)AVE} at a wavelength of 600 nm to 700 nm and an incident angle of 0 degrees is 30% or more.
(i-5) An absolute value of a difference between the average transmittance T_{600-700(0deg)AVE} and an average transmittance T_{600-700(60deg)AVE} at a wavelength of 600 nm to 700 nm and an incident angle of 60 degrees is 10% or less.
(i-6) An average transmittance T_{750-1100(0deg)AVE} at a wavelength of 750 nm to 1,100 nm and an incident angle of 0 degrees is 0.5% or less.
(i-7) An absolute value of a difference between the average transmittance T_{750-1100(0deg)AVE} and an average transmittance T_{750-1100(60deg)AVE} at a wavelength of 750 nm to 1,100 nm and an incident angle of 60 degrees is 0.5% or less.
(i-8) In a wavelength of 750 nm to 1,100 nm, an absolute value of a difference between a transmittance at an incident angle of 0 degrees and a transmittance at an incident angle of 60 degrees is 0.7% or less at maximum.

### Advantageous Effects of Invention

According to the present invention, it is possible to provide an optical filter in which a ripple in a visible light region is prevented even with incident light having a high incident angle, and a transmittance in the visible light region and shielding properties in a near-infrared light region are excellent.

### BRIEF DESCRIPTION OF DRAWINGS

FIG. 1 is a cross-sectional view schematically illustrating an example of an optical filter according to one embodiment.

FIG. 2 is a diagram illustrating a spectral transmittance curve of phosphate glass 2.

FIG. 3 is a diagram illustrating a spectral transmittance curve of a resin film of Example 1-1.

FIG. 4 is a diagram illustrating spectral transmittance curves of an optical filter of Example 2-1.

FIG. 5 is a diagram illustrating spectral reflectance curves of the optical filter of Example 2-1.

FIG. 6 is a diagram illustrating spectral transmittance curves of an optical filter of Example 2-2.

FIG. 7 is a diagram illustrating spectral reflectance curves of the optical filter of Example 2-2.

FIG. 8 is a diagram illustrating spectral transmittance curves of an optical filter of Example 2-5.

FIG. 9 is a diagram illustrating spectral reflectance curves of the optical filter of Example 2-5.

### DESCRIPTION OF EMBODIMENTS

Hereinafter, embodiments of the present invention are described.
In the present description, a near-infrared ray absorbing dye may be abbreviated as an “NIR dye”, and an ultraviolet absorbing dye may be abbreviated as a “UV dye”.
In the present description, a compound represented by a formula (I) is referred to as a compound (I). The same applies to compounds represented by other formulae. A dye composed of the compound (I) is also referred to as a dye (I), and the same applies to other dyes. A group represented by the formula (I) is also referred to as a group (I), and the same applies to groups represented by other formulae.

In the present description, an internal transmittance is a transmittance obtained by subtracting an influence of interface reflection from a measured transmittance, which is represented by a formula of {measured transmittance (incident angle of 0 degrees)/(100−reflectance (incident angle of 5 degrees))}×100.

In the present description, a transmittance of, for example, 90% or more in a specific wavelength region means that the transmittance does not fall below 90% in the entire wavelength region, that is, a minimum transmittance in the wavelength region is 90% or more. Similarly, a transmittance of, for example, 1% or less in a specific wavelength region means that the transmittance does not exceed 1% in the entire wavelength region, that is, a maximum transmittance in the wavelength region is 1% or less. The same applies to the internal transmittance. An average transmittance and an average internal transmittance in the specific wavelength region are the arithmetic mean of a transmittance and an internal transmittance per 1 nm in the wavelength region.
Spectral characteristics can be measured by using an ultraviolet-visible spectrophotometer.
In the present description, the word “to” that is used to express a numerical range includes upper and lower limits of the range.

### Optical Filter

An optical filter according to one embodiment of the present invention (hereinafter, also referred to as “optical filter according to the present embodiment”) includes a dielectric multilayer film 1, a resin film, a phosphate glass, and a dielectric multilayer film 2 in this order.

Here, the resin film includes a resin and a near-infrared ray absorbing dye having a maximum absorption wavelength in 690 nm to 800 nm in the resin, and a thickness of the resin film is 10 μm or less.

In the present invention, the dielectric multilayer film has small reflection characteristics even at a high incident angle as to be described later, and light-shielding properties of the optical filter is substantially ensured by absorption characteristics of the phosphate glass and the near-infrared ray absorbing dye. Since the absorption characteristics are not affected by the incident angle of light, the optical filter as a whole can achieve an excellent transmittance in the visible light region and excellent shielding properties in the near-infrared light region while preventing a ripple in the visible light region.

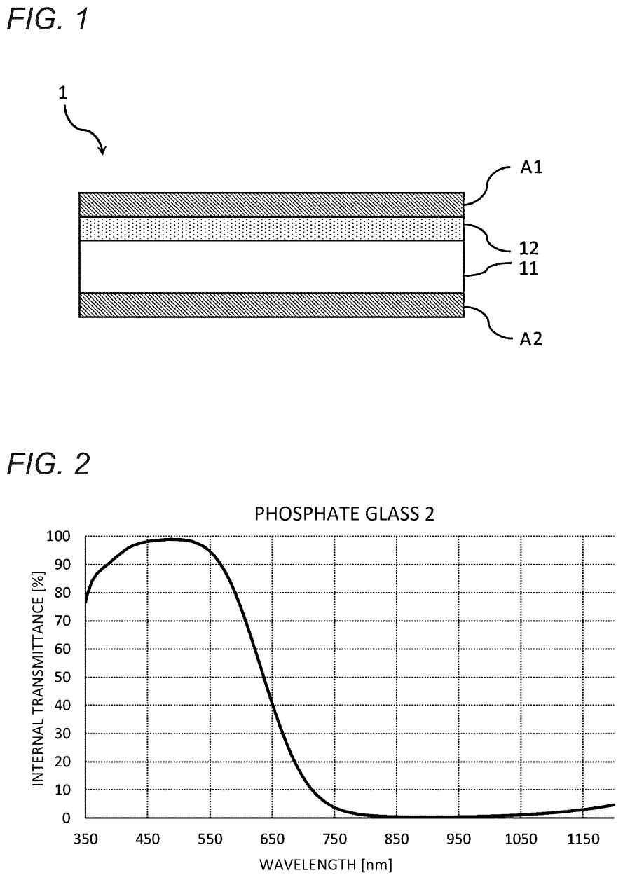

An example of a configuration of the filter is described with reference to the drawings. FIG. 1 is a cross-sectional view schematically illustrating an example of the optical filter according to one embodiment.

An optical filter 1 illustrated in FIG. 1 includes a dielectric multilayer film A1, a resin film 12, a phosphate glass 11, and a dielectric multilayer film A2 in this order.

The optical filter according to the present embodiment satisfies all of the following spectral characteristics (i-1) to (i-8).
(i-1) An average transmittance T_{450-600(0deg)AVE} at a wavelength of 450 nm to 600 nm and an incident angle of 0 degrees is 88.5% or more.
(i-2) An absolute value of a difference between the average transmittance T_{450-600(0deg)AVE} and an average transmittance T_{450-600(60deg)AVE} at a wavelength of 450 nm to 600 nm and an incident angle of 60 degrees is 6% or less.
(i-3) In a wavelength of 450 nm to 600 nm, an absolute value of a difference between a transmittance at an incident angle of 0 degrees and a transmittance at an incident angle of 60 degrees is 8% or less at maximum.
(i-4) An average transmittance T_{600-700(0deg)AVE} at a wavelength of 600 nm to 700 nm and an incident angle of 0 degrees is 30% or more.
(i-5) An absolute value of a difference between the average transmittance T_{600-700(0deg)AVE} and an average transmittance T_{600-700(60deg)AVE} at a wavelength of 600 nm to 700 nm and an incident angle of 60 degrees is 10% or less.
(i-6) An average transmittance T_{750-1100(0deg)AVE} at a wavelength of 750 nm to 1,100 nm and an incident angle of 0 degrees is 0.5% or less.
(i-7) An absolute value of a difference between the average transmittance T_{750-1100(0deg)AVE} and an average transmittance T_{750-1100(60deg)AVE} at a wavelength of 750 nm to 1,100 nm and an incident angle of 60 degrees is 0.5% or less.
(i-8) In a wavelength of 750 nm to 1,100 nm, an absolute value of a difference between a transmittance at an incident angle of 0 degrees and a transmittance at an incident angle of 60 degrees is 0.7% or less at maximum.

The filter satisfying all of the spectral characteristics (i-1) to (i-8) particularly has a high transmittance of visible light as shown in the characteristic (i-1) and high shielding properties of near-infrared light as shown in the characteristic (i-6). Further, as shown in the characteristics (i-2) and (i-3), a change in spectral characteristic due to a high incident angle in the visible light region is small, and a ripple in the visible light region is prevented.

Satisfying the spectral characteristic (i-1) means that a transmittance in a visible light region of 450 nm to 600 nm is excellent.
T_{450-600(0deg)AVE} is preferably 88.6% or more, and more preferably 88.8% or more.
The spectral characteristic (i-1) can be achieved, for example, by using a dielectric multilayer film having a low reflectance in the visible light region and by using a near-infrared ray absorbing dye and a phosphate glass having a high transmittance in the visible light region.

The spectral characteristics (i-2) and (i-3) show a difference between the transmittance at an incident angle of 0 degrees and the transmittance at an incident angle of 60 degrees in the visible light region, the spectral characteristic (i-2) shows a difference between average values, and the spectral characteristic (i-3) shows a maximum value when each difference is taken for each corresponding wavelength. Satisfying the characteristics (i-2) and (i-3) means that the change in spectral characteristic due to a high incident angle in the visible light region is small, and the ripple in the visible light region is prevented.

The absolute value of the difference between the average transmittance T_{450-600(0deg)AVE} and the average transmittance T_{450-600(60deg)AVE} is preferably 5.5% or less, and more preferably 5.1% or less.

The absolute value of the difference between the transmittance at an incident angle of 0 degrees and the transmittance at an incident angle of 60 degrees is preferably 7.9% or less, and more preferably 7.8% or less at maximum.

The spectral characteristics (i-2) and (i-3) can be achieved, for example, by using a dielectric multilayer film having a low reflectance in the visible light region.

Satisfying the spectral characteristics (i-4) and (i-5) means that a spectral curve with a high incident angle is less likely to shift in a region of 600 nm to 700 nm in which a variation amount of the transmittance due to a change in wavelength is large.
The average transmittance T_{600-700(0deg)AVE} is preferably 31% or more, and more preferably 31.9% or more.
The absolute value of the difference between the average transmittance T_{600-700(0deg)AVE} and the average transmittance T_{600-700(60deg)AVE} is preferably 9.7% or less, and more preferably 9.4% or less.

The spectral characteristics (i-4) and (i-5) can be achieved, for example, by shielding light utilizing absorption characteristics of the near-infrared ray absorbing dye and the phosphate glass.

Satisfying the spectral characteristic (i-6) means that light-shielding properties in an infrared region of 750 nm to 1,100 nm are excellent.
T_{750-1100(0deg)AVE} is preferably 1.2% or less, and more preferably 1.0% or less.
The spectral characteristic (i-6) can be achieved, for example, by shielding light utilizing the absorption characteristics of the near-infrared ray absorbing dye and the phosphate glass.

The spectral characteristics (i-7) and (i-8) show a difference between the transmittance at an incident angle of 0 degrees and the transmittance at an incident angle of 60 degrees in the near-infrared light region, the spectral characteristic (i-7) shows a difference between average values, and the spectral characteristic (i-8) shows a maximum value when each difference is taken for each corresponding wavelength.
Satisfying the spectral characteristics (i-7) and (i-8) means that a change in spectral characteristic due to a high incident angle in the near-infrared light region is small.
The absolute value of the difference between the average transmittance T_{750-1100(0deg)AVE} and the average transmittance T_{750-1100(60deg)AVE} is preferably 0.4% or less, and more preferably 0.25% or less.
The absolute value of the difference between the transmittance at an incident angle of 0 degrees and the transmittance at an incident angle of 60 degrees is preferably 0.68% or less, and more preferably 0.66% or less at maximum.
The spectral characteristics (i-7) and (i-8) can be achieved, for example, by shielding light utilizing the absorption characteristics of the near-infrared ray absorbing dye and the phosphate glass.

The optical filter according to the present embodiment preferably further satisfies the following spectral characteristics (i-9) and (i-10).
(i-9) In a wavelength of 450 nm to 600 nm, a difference between a maximum value and a minimum value of the absolute value of the difference between the transmittance at an incident angle of 0 degrees and the transmittance at an incident angle of 60 degrees is 6% or less.
(i-10) In a wavelength of 750 nm to 1,100 nm, a difference between a maximum value and a minimum value of the absolute value of the difference between the transmittance at an incident angle of 0 degrees and the transmittance at an incident angle of 60 degrees is 1% or less.
Satisfying the spectral characteristics (i-9) and (i-10) means that a spike of the ripple is low and a wavelength dependence is also low.
In a wavelength of 450 nm to 600 nm, the difference between the maximum value and the minimum value of the absolute value of the difference between the transmittance at an incident angle of 0 degrees and the transmittance at an incident angle of 60 degrees is more preferably 5.5% or less, and further preferably 5.1% or less.
In a wavelength of 750 nm to 1,100 nm, the difference between the maximum value and the minimum value of the absolute value of the difference between the transmittance at an incident angle of 0 degrees and the transmittance at an incident angle of 60 degrees is more preferably 0.8% or less, and further preferably 0.6% or less.
The spectral characteristics (i-9) and (i-10) can be achieved, for example, by using a dielectric multilayer film having a low reflectance in the visible light region and the near-infrared light region.

The optical filter according to the present embodiment preferably further satisfies the following spectral characteristics (i-11) and (i-12).
(i-11) When a dielectric multilayer film 2 side is set as an incident direction, an average of an absorption loss amount₄₅₀₋₆₀₀ defined below in a wavelength of 450 nm to 600 nm is 10% or less: (absorption loss amount₄₅₀₋₆₀₀) [%]=100−(transmittance at incident angle of 5 degrees)−(reflectance at incident angle of 5 degrees).
(i-12) When a dielectric multilayer film 2 side is set as an incident direction, an average of an absorption loss amount₇₅₀₋₁₂₀₀ defined below in a wavelength of 750 nm to 1,200 nm is 60% or more: (absorption loss amount₇₅₀₋₁₂₀₀) [%]=100−(transmittance at incident angle of 5 degrees)−(reflectance at incident angle of 5 degrees).
The spectral characteristic (i-11) means that the absorption loss amount in the visible light region is small.
The spectral characteristic (i-12) means that the absorption loss amount in the near-infrared light region is large.
Satisfying the spectral characteristics (i-11) and (i-12) means that light in the visible light region is less likely to be absorbed, that is, the transmittance is high, and light in the near-infrared light region is shielded by absorption.
The average of the absorption loss amount₄₅₀₋₆₀₀ is more preferably 9.8% or less, and further preferably 9.6% or less.
The average of the absorption loss amount₇₅₀₋₁₂₀₀ is more preferably 60.2% or more.
The spectral characteristics (i-11) and (i-12) can be achieved, for example, by using a dielectric multilayer film having a low reflectance in the visible light region and by using the near-infrared ray absorbing dye and the phosphate glass having a high transmittance in the visible light region.

The optical filter according to the present embodiment preferably further satisfies the following spectral characteristics (i-13) and (i-14).
(i-13) When a dielectric multilayer film 2 side is set as an incident direction, an average reflectance R2_{450-600(5deg)AVE} at a wavelength of 450 nm to 600 nm and an incident angle of 5 degrees is 2% or less.
(i-14) When a dielectric multilayer film 2 side is set as an incident direction, an average reflectance R2_{750-1200(5deg)AVE} at a wavelength of 750 nm to 1,200 nm and an incident angle of 5 degrees is 35% or less.
Satisfying the spectral characteristic (i-13) means that a reflectance in the visible light region is small. Satisfying the spectral characteristic (i-14) means that light in a near-infrared light region is appropriately reflected.
The average reflectance R2_{450-600(5deg)AVE} is more preferably 1.8% or less, and further preferably 1.65% or less.
The average reflectance R2_{750-1200(5deg)AVE} is more preferably 33% or less, and further preferably 32.5% or less.

The spectral characteristics (i-13) and (i-14) can be achieved, for example, by using the dielectric multilayer film 2 designed such that the reflectance in the visible light region becomes low and light in the near-infrared light region is appropriately reflected.

### Dielectric Multilayer Film

In the filter, the dielectric multilayer film 1 is laminated on a resin film side, and the dielectric multilayer film 2 is laminated on a phosphate glass side.

In the filter, it is preferable that at least the dielectric multilayer film 2 is designed as a near-infrared ray antireflection layer (hereinafter, also referred to as an NIR antireflection layer), and more preferable that both the dielectric multilayer film 1 and the dielectric multilayer film 2 are designed as near-infrared ray antireflection layers. Thus, an optical filter in which ripple generation in the visible light region is reduced and spectral characteristics are less likely to change with respect to light having a high incident angle is obtained.

The NIR antireflection layer is composed of, for example, a dielectric multilayer film in which dielectric films having different refractive indices are laminated. More specifically, examples of the dielectric films include a dielectric film having a low refractive index (low refractive index film), a dielectric film having a medium refractive index (medium refractive index film), and a dielectric film having a high refractive index (high refractive index film), and the NIR antireflection layer is composed of a dielectric multilayer film in which two or more of those dielectric films are laminated.
A refractive index of the high refractive index film at a wavelength of 500 nm is preferably 1.6 or more, and more preferably 2.2 to 2.5. Examples of a material of the high refractive index film include Ta₂O₅, TiO₂, TiO, and Nb₂O₅. Other commercially available products thereof include OS50 (Ti₃O₅), OS10 (Ti₄O₇), OA500 (mixture of Ta₂O₅ and ZrO₂), and OA600 (mixture of Ta₂O₅ and TiO₂) manufactured by Canon Optron, Inc. Among those, TiO₂ is preferable from the viewpoint of reproducibility in film formability and refractive index, stability, and the like.

A refractive index of the medium refractive index film at a wavelength of 500 nm is preferably 1.6 or more and less than 2.2. Examples of a material of the medium refractive index film include ZrO₂, Nb₂O₅, Al₂O₃, HfO₂, OM-4, OM-6 (mixtures of Al₂O₃ and ZrO₂), and OA-100, sold by Canon Optron, Inc., and H4 and M2 (alumina lanthania) sold by Merck KGaA. Among those, Al₂O₃-based compounds and mixtures of Al₂O₃ and ZrO₂ are preferable from the viewpoint of reproducibility in film formability and refractive index, stability, and the like.

A refractive index of the low refractive index film at a wavelength of 500 nm is preferably less than 1.6, and more preferably 1.38 to 1.5. Examples of a material of the low refractive index film include SiO₂, SiOₓN_{y}, and MgF₂. Other commercially available products thereof include S4F and S5F (mixtures of SiO₂ and Al₂O₃) manufactured by Canon Optron, Inc. Among those, SiO₂ is preferable from the viewpoint of reproducibility in film formability, stability, economic efficiency, and the like.

It is preferable that at least one of the dielectric multilayer film 1 and the dielectric multilayer film 2 includes three or more dielectric layers having different refractive indices. Thus, a dielectric multilayer film having a low reflectance is easily obtained. When three or more dielectric layers having different refractive indices are included, it is particularly preferable to include SiO₂, TiO₂, Al₂O₃, and MgF₂.

In order to obtain a dielectric multilayer film in which reflection characteristics are prevented as described above, several types of dielectric layers having different spectral characteristics may be combined when transmitting and selecting a desired wavelength band.

As the dielectric multilayer film, it is preferable that at least one of the dielectric multilayer film 1 and the dielectric multilayer film 2 includes one or more dielectric layers having a refractive index of 1.38 to 1.5 at a wavelength of 500 nm, and more preferably, each of the dielectric multilayer film 1 and the dielectric multilayer film 2 includes one or more corresponding layers.

Further, it is preferable that at least one of the dielectric multilayer film 1 and the dielectric multilayer film 2 includes one or more dielectric layers formed of MgF₂. In particular, it is preferable that each of the dielectric multilayer film 1 and the dielectric multilayer film 2 includes one or more dielectric layers formed of MgF₂. Thus, a dielectric multilayer film having a low reflectance even at a high incident angle is easily obtained.

It is preferable that at least one of two uppermost layers of the dielectric multilayer film is an MgF₂ layer, more preferable that the outermost layer (that is, the uppermost layer not in contact with the resin film or the phosphate glass) is an MgF₂ layer, and further preferable that both of the uppermost layers are MgF₂ layers. In such an embodiment, a dielectric multilayer film having a low reflectance even at a high incident angle is easily obtained. An effect such as improving dust resistance in the case where the outermost layer is a MgF₂ layer and improving peeling resistance of a film in the case where the MgF₂ layer is in contact with the resin film or the phosphate glass is also expectable.

The total number of laminated layers of dielectric multilayer films in the NIR antireflection layer is preferably 25 or less, more preferably 20 or less, and further preferably 17 or less, and is preferably 10 or more. In order to prevent reflection in a visible wavelength band even when the incident angle is changed, a film having a low reflectance in the entire wavelength band is preferable rather than a film that reflects light of a specific wavelength.
A thickness of the antireflection layer is preferably 200 μm to 600 μm as a whole.
The antireflection layer formed of the dielectric multilayer film 1 and the antireflection layer formed of the dielectric multilayer film 2 each preferably satisfy the above number of laminated layers and thickness.

For formation of the dielectric multilayer film, for example, a vacuum film formation process such as a CVD method, a sputtering method, or a vacuum deposition method, a wet film formation process such as a spraying method or a dipping method, or the like can be used.

The NIR antireflection layer may provide predetermined optical characteristics by one layer (one group of dielectric multilayer films) or may provide the predetermined optical characteristics by two layers. When two or more antireflection layers are provided, the respective antireflection layers may have the same configuration or different configurations.

When the optical filter is mounted on the imaging device, the dielectric multilayer film 2 laminated on a glass surface is generally disposed on a lens side, and the dielectric multilayer film 1 laminated on a resin film surface is generally disposed on a sensor side.

### Phosphate Glass

The phosphate glass in the optical filter according to the present embodiment functions as an infrared ray absorbing glass.
The phosphate glass preferably satisfies all of the following spectral characteristics (ii-1) to (ii-5).
(ii-1) An internal transmittance T₄₅₀ at a wavelength of 450 nm is 92% or more.
(ii-2) An average internal transmittance T_{450-600AVE} at a wavelength of 450 nm to 600 nm is 90% or more.
(ii-3) IR50 at which an internal transmittance is 50% is in a wavelength range of 625 nm to 650 nm.
(ii-4) An average internal transmittance T_{750-1000AVE} at a wavelength of 750 nm to 1,000 nm is 2.5% or less.
(ii-5) An average internal transmittance T_{1000-1200AVE} at a wavelength of 1,000 nm to 1,200 nm is 7% or less.

Satisfying the spectral characteristic (ii-1) means that a transmittance in a blue light region is excellent, and satisfying the spectral characteristic (ii-2) means that the transmittance in the visible light region of 450 nm to 600 nm is excellent.
The internal transmittance T₄₅₀ is more preferably 93% or more, and further preferably 95% or more.
The average internal transmittance T_{450-600AVE} is more preferably 94% or more, and further preferably 95% or more.

Satisfying the spectral characteristic (ii-3) means that light in the near-infrared light region can be shielded and visible transmitted light can be efficiently taken in.
IR50 is more preferably in a range of 625 nm to 645 nm, and further preferably in a range of 625 nm to 640 nm.

Satisfying the spectral characteristic (ii-4) means that the light-shielding properties in the near-infrared region of 750 nm to 1,000 nm are excellent.
The average internal transmittance T_{750-1000AVE} is more preferably 2% or less, and further preferably 1.2% or less.

Satisfying the spectral characteristic (ii-5) means that the light-shielding properties in an infrared region of 1,000 nm to 1,200 nm are excellent.
The average internal transmittance T_{1000-1200AVE} is more preferably 2.3% or less, and further preferably 2.2% or less.

It is preferable that the phosphate glass start to absorb near-infrared light from a region of 625 nm to 650 nm as shown in the above characteristic (ii-3), and exhibits high light-shielding properties after 750 nm as shown in the above characteristic (ii-4). Accordingly, the light-shielding properties of the above-described dielectric multilayer film can be compensated.

In the present invention, the phosphate glass preferably contains copper ions. By containing copper ions that absorb light having a wavelength in the vicinity of 900 nm, near-infrared light of 700 nm to 1,200 nm can be shielded. The phosphate glass also includes a phosphosilicate glass in which a part of a skeleton of the glass is formed of SiO₂.

For example, it is preferable that the phosphate glass contains the following components constituting glass. Respective content ratios of the following glass constituent components are expressed in mass % in terms of oxides.

P₂O₅ is a main component forming the glass, and is an essential component for enhancing a near-infrared ray cutting property. When a content of P₂O₅ is 40% or more, an effect thereof can be sufficiently obtained, and when the content of P₂O₅ is 80% or less, problems such as glass instability and reduction in the weather resistance are less likely to occur. Therefore, the content of P₂O₅ is preferably 40% to 80%, more preferably 45% to 78%, further preferably 50% to 77%, still more preferably 55% to 76%, and most preferably 60% to 75%.

Al₂O₃ is a main component forming glass, and is a component for enhancing strength of the glass, enhancing the weather resistance of the glass, and the like. When a content of Al₂O₃ is 0.5% or more, an effect thereof can be sufficiently obtained, and when the content of Al₂O₃ is 20% or less, problems such as glass instability and reduction in near-infrared ray cutting property are less likely to occur. Therefore, the content of Al₂O₃ is preferably 0.5% to 20%, more preferably 1.0% to 20%, further preferably 2.0% to 18%, still more preferably 3.0% to 17%, particularly preferably 4.0% to 16%, and most preferably 5.0% to 15.5%.

R₂O (where R₂O is one or more components selected from Li₂O, Na₂O, K₂O, Rb₂O, and Cs₂O) is a component for lowering a melting temperature of the glass, lowering a liquid phase temperature of the glass, stabilizing the glass, and the like. When a total content of R₂O (ΣR₂O) is 0.5% or more, an effect thereof is sufficiently obtained, and when the total content of R₂O is 20% or less, glass instability is less likely to occur, which is preferable. Therefore, the total content of R₂O is preferably 0.5% to 20%, more preferably 1.0% to 19%, further preferably 1.5% to 18%, still more preferably 2.0% to 17%, particularly preferably 2.5% to 16%, and most preferably 3.0% to 15.5%.

Li₂O is a component for lowering the melting temperature of the glass, lowering the liquid phase temperature of the glass, stabilizing the glass, and the like. A content of Li₂O is preferably 0% to 15%. When the content of Li₂O is 15% or less, problems such as glass instability and reduction in near-infrared ray cutting property are less likely to occur, which is preferable. The content of Li₂O is more preferably 0% to 8%, further preferably 0% to 7%, still more preferably 0% to 6%, and most preferably 0% to 5%.

Na₂O is a component for lowering the melting temperature of the glass, lowering the liquid phase temperature of the glass, stabilizing the glass, and the like. A content of Na₂O is preferably 0% to 15%. When the content of Na₂O is 15% or less, glass instability is less likely to occur, which is preferable. The content of Na₂O is more preferably 0.5% to 14%, further preferably 1% to 13%, still more preferably 2% to 13%, and most preferably 3% to 13%.

K₂O is a component having effects such as lowering the melting temperature of the glass and lowering the liquid phase temperature of the glass. A content of K₂O is preferably 0% to 20%. When the content of K₂O is 20% or less, glass instability is less likely to occur, which is preferable. The content of K₂O is more preferably 0.5% to 19%, further preferably 1% to 18%, still more preferably 2% to 17%, and most preferably 3% to 16%.

Rb₂O is a component having effects such as lowering the melting temperature of the glass and lowering the liquid phase temperature of the glass. A content of Rb₂O is preferably 0% to 15%. When the content of Rb₂O is 15% or less, glass instability is less likely to occur, which is preferable. The content of Rb₂O is more preferably 0.5% to 14%, further preferably 1% to 13%, still more preferably 2% to 13%, and most preferably 3% to 13%.

Cs₂O is a component having effects such as lowering the melting temperature of the glass and lowering the liquid phase temperature of the glass. A content of Cs₂O is preferably 0% to 15%. When the content of Cs₂O is 15% or less, glass instability is less likely to occur, which is preferable. The content of Cs₂O is more preferably 0.5% to 14%, further preferably 1% to 13%, still more preferably 2% to 13%, and most preferably 3% to 13%.

When two or more of the above alkali metal components represented by R₂O are added at the same time, a mixed alkali effect is generated in the glass, and a mobility of R⁺ ions is reduced. Accordingly, when the glass comes into contact with water, a hydration reaction caused by ion exchange between H⁺ ions in water molecules and the R⁺ ions in the glass is inhibited, and the weather resistance of the glass is improved. Therefore, the glass of the present embodiment preferably contains two or more components selected from Li₂O, Na₂O, K₂O, Rb₂O, and Cs₂O. In this case, the total content (ΣR₂O) of R₂O (where R₂O is Li₂O, Na₂O, K₂O, Rb₂O, and Cs₂O) is preferably 7% to 18% (where 7% is excluded). When the total content of R₂O is more than 7%, the effect thereof is sufficiently obtained, and when the total content of R₂O is 18% or less, problems such as glass instability, reduction in near-infrared ray cutting property, and reduction in strength of the glass are less likely to occur, which is preferable. Therefore, ΣR₂O is preferably more than 7% and 18% or less, more preferably 7.5% to 17%, further preferably 8% to 16%, still more preferably 8.5% to 15%, and most preferably 9% to 14%.

R′O (where R′O is one or more components selected from CaO, MgO, BaO, SrO, and ZnO) is a component for lowering the melting temperature of the glass, lowering the liquid phase temperature of the glass, stabilizing the glass, enhancing the strength of the glass, and the like. A total content of R′O (ΣR′O) is preferably 0% to 40%. When the total content of R′O is 40% or less, problems such as glass instability, reduction in near-infrared ray cutting property, and reduction in strength of the glass are less likely to occur, which is preferable. The total content of R′O is more preferably 0% to 35%, and further preferably 0% to 30%. The total content of R′O is still more preferably 0% to 25%, particularly preferably 0% to 8%, and most preferably 0% to 15%.

CaO is a component for lowering the melting temperature of the glass, lowering the liquid phase temperature of the glass, stabilizing the glass, enhancing the strength of the glass, and the like. A content of CaO is preferably 0% to 10%. When the content of CaO is 10% or less, problems such as glass instability and reduction in near-infrared ray cutting property are less likely to occur, which is preferable. The content of CaO is more preferably 0% to 8%, further preferably 0% to 6%, still more preferably 0% to 5%, and most preferably 0% to 4%.

MgO is a component for lowering the melting temperature of the glass, lowering the liquid phase temperature of the glass, stabilizing the glass, enhancing the strength of the glass, and the like. A content of MgO is preferably 0% to 15%. When the content of MgO is 15% or less, problems such as glass instability and reduction in near-infrared ray cutting property are less likely to occur, which is preferable. The content of MgO is more preferably 0% to 13%, further preferably 0% to 10%, still more preferably 0% to 9%, and most preferably 0% to 8%.

BaO is a component for lowering the melting temperature of the glass, lowering the liquid phase temperature of the glass, stabilizing the glass, and the like. A content of BaO is preferably 0% to 40%. When the content of BaO is 40% or less, problems such as glass instability and reduction in near-infrared ray cutting property are less likely to occur, which is preferable. The content of BaO is more preferably 0% to 30%, further preferably 0% to 20%, still more preferably 0% to 10%, and most preferably 0% to 5%.

SrO is a component for lowering the melting temperature of the glass, lowering the liquid phase temperature of the glass, stabilizing the glass, and the like. A content of SrO is preferably 0% to 10%. When the content of SrO is 10% or less, problems such as glass instability and reduction in near-infrared ray cutting property are less likely to occur, which is preferable. The content of SrO is more preferably 0% to 8%, further preferably 0% to 7%, and most preferably 0% to 6%.

ZnO has effects such as lowering the melting temperature of the glass and lowering the liquid phase temperature of the glass. A content of ZnO is preferably 0% to 15%. When the content of ZnO is 15% or less, problems such as glass instability, deterioration in solubility of the glass, and reduction in near-infrared ray cutting property are less likely to occur, which is preferable. The content of ZnO is more preferably 0% to 13%, further preferably 0% to 10%, still more preferably 0% to 9%, and most preferably 0% to 8%.

CuO is a component for cutting near-infrared rays. When a content of CuO is 0.5% or more, an effect thereof and an effect of increasing a transmittance of light in the visible region of the glass obtained in the case where MoO₃ to be described later is contained can be sufficiently obtained, and when the content of CuO is 40% or less, problems such as generation of devitrification foreign matters in the glass and reduction in transmittance of light in a visible region are less likely to occur, which is preferable. The content of CuO is more preferably 1.0% to 35%, further preferably 1.5% to 30%, still more preferably 2.0% to 25%, and most preferably 2.5% to 20%.

MoO₃ is a component for increasing the transmittance of light in the visible region of the glass, and is preferably contained together with CuO. The inventor prepared a phosphate glass containing Cu (not containing a fluorine component) and a phosphate glass additionally containing Mo with respect to the glass, and confirmed optical characteristics thereof. As a result, the inventor confirmed that in the latter glass, a transmittance of light having a wavelength of 400 nm to 540 nm was significantly increased as compared to that in the former glass. This phenomenon, although it is a hypothesis, is considered to be due to the following reasons.
Mo is known to exist in a glass as Mo⁶⁺ (hexavalent). However, when Mo and Cu are co-doped in the phosphate glass, Cu⁺ in the glass releases an electron (e⁻) and becomes Cu²⁺ (Cu⁺→Cu²⁺+e⁻), and Mo⁶⁺ receives the electron released by Cu⁺ and becomes Mo⁵⁺ (pentavalent) (Mo⁶⁺+e⁻→Mo⁵⁺). As a result, a proportion of Cu⁺ (monovalent) that has absorption characteristics in the vicinity of a wavelength of 300 nm to 600 nm is reduced, and the transmittance of light having a wavelength of 400 nm to 540 nm is increased. It is considered that since Mo⁵⁺ has a characteristic of absorbing light having a wavelength of about 400 nm, a transmittance of light having a wavelength of about 400 nm is not increased. In the related art, a phosphate glass containing Cu and Mo has not been known, and the above is considered to be a new finding found by the present inventors.

When a content of MoO₃ is 0.01% or more, the effect of increasing the transmittance of light in the visible region of the glass can be sufficiently obtained, and when the content of MoO₃ is 10% or less, problems such as reduction in near-infrared ray cutting property and generation of devitrification foreign matters in the glass are less likely to occur, which is preferable. The content of MoO₃ is more preferably 0.02% to 9%, further preferably 0.03% to 8%, still more preferably 0.04% to 7%, and most preferably 0.05% to 6%.

In the glass according to the present embodiment, F may be contained in a range of 10% or less in order to enhance the weather resistance. When a content of F is 10% or less, problems such as reduction in near-infrared ray cutting property and generation of devitrification foreign matters in the glass are less likely to occur, which is preferable. The content of F is more preferably 9% or less, further preferably 8% or less, still more preferably 7% or less, particularly preferably 6% or less, and most preferably 5% or less.

B₂O₃ may be contained in a range of 10% or less for stabilizing the glass. When a content of B₂O₃ is 10% or less, problems such as deterioration in weather resistance of the glass and reduction in near-infrared ray cutting property are less likely to occur, which is preferable. The content of B₂O₃ is more preferably 9% or less, further preferably 8% or less, still more preferably 7% or less, particularly preferably 6% or less, and most preferably 5% or less.

SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 5% or less in order to improve the weather resistance of the glass. When a content of these components is 5% or less, problems such as generation of devitrification foreign matters in the glass and reduction in near-infrared ray cutting property are less likely to occur, which is preferable. The content of these components is preferably 4% or less, further preferably 3% or less, particularly preferably 2% or less, and still more preferably 1% or less.

Any of Fe₂O₃, Cr₂O₃, Bi₂O₃, NiO, V₂O₅, MnO₂, and CoO is a component that reduces the transmittance of light in the visible region by being present in the glass. Therefore, it is preferable that these components are not substantially contained in the glass.
In the present invention, the expression “a specific component is not substantially contained” means that the component is not intentionally added, and does not exclude inclusion of the component to the extent that the component is unavoidably mixed in from raw materials, or the like, and does not affect desired properties.

A thickness of the phosphate glass is preferably 0.5 mm or less and more preferably 0.3 mm or less from the viewpoint of a reduction in height of camera modules, and is preferably 0.1 mm or more and more preferably 0.15 mm or more from the viewpoint of maintenance of device strength.

The phosphate glass can be prepared as follows, for example.
First, raw materials are weighed and mixed so as to fall within the above composition range (mixing step). The raw material mixture is accommodated in a platinum crucible, and heated and melted at a temperature of 700° C. to 1,400° C. in an electric furnace (melting step).

After being sufficiently stirred and refined, the raw material mixture is cast into a mold, cut and polished to form a flat plate having a predetermined thickness (molding step).

In the melting step of the above manufacturing method, the highest temperature of the glass during glass melting is preferably 1,400° C. or lower. When the highest temperature of the glass during glass melting is higher than the above temperature, transmittance characteristics may deteriorate. The above temperature is more preferably 1,350° C. or lower, further preferably 1,300° C. or lower, and still more preferably 1,250° C. or lower.

When the temperature in the above melting step is too low, problems such as occurrence of devitrification during melting and requirement of a long time for burn through may occur, and thus the temperature is preferably 700° C. or higher, and more preferably 800° C. or higher.

### Resin Film

The resin film in the optical filter according to the present embodiment includes the resin and the near-infrared ray absorbing dye having a maximum absorption wavelength in 690 nm to 800 nm in the resin. Here, the resin refers to a resin constituting the resin film.

The resin film preferably satisfies all of the following spectral characteristics (iii-1) to (iii-3).
(iii-1) An internal transmittance T₄₅₀ at a wavelength of 450 nm is 85% or more.
(iii-2) An average internal transmittance T_{450-600AVE} at the wavelength of 450 nm to 600 nm is 90% or more.
(iii-3) A wavelength IR50 at which an internal transmittance is 50% is in a range of 620 nm to 750 nm.

Satisfying the spectral characteristic (iii-1) means that a transmittance in a blue light region is excellent.
The internal transmittance T₄₅₀ is more preferably 95% or more, and further preferably 98% or more.

Satisfying the spectral characteristic (iii-2) means that the transmittance in the visible light region of 450 nm to 600 nm is excellent.
The average internal transmittance T_{450-600AVE} is more preferably 92% or more, and further preferably 94% or more.

Satisfying the spectral characteristic (iii-3) means that light in the near-infrared region can be shielded and visible transmitted light can be efficiently taken in.
The wavelength IR50 is more preferably in a range of 640 nm to 740 nm, and further preferably in a range of 650 nm to 730 nm.

Since the resin film of the present invention contains a dye having a maximum absorption wavelength in 690 nm to 800 nm, a near-infrared light region in the vicinity of 700 nm where the light-shielding properties are slightly weak in the phosphate glass can be shielded by absorption characteristics of the dye.

Examples of the near-infrared ray absorbing dye include at least one selected from the group consisting of a cyanine dye, a phthalocyanine dye, a squarylium dye, a naphthalocyanine dye, and a diimonium dye, and one thereof or a plurality thereof as a mixture can be used. Among those, the squarylium dye and the cyanine dye are preferable from the viewpoint of easily exhibiting the effect of the present invention.

A content of the near-infrared ray absorbing dye in the resin film is preferably 0.1 parts by mass to 30 parts by mass, and more preferably 0.1 parts by mass to 20 parts by mass with respect to 100 parts by mass of the resin. When two or more compounds are combined, the above content is a sum of respective compounds.

The resin film may contain other dyes, for example, an ultraviolet light-absorbing dye, as long as the effect of the present invention is not impaired.
Examples of the ultraviolet light-absorbing dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among those, the merocyanine dye is particularly preferable. These dyes may be used alone, or may be used in combination of two or more kinds thereof.

The resin is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly (p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.
One or more kinds of resins selected from the polyimide resin, the polycarbonate resin, the polyester resin, and the acrylic resin are preferable from the viewpoint of spectral characteristics, a glass transition temperature (Tg), and adhesion of the resin film.

When a plurality of dyes are used, these dyes may be contained in the same resin film or may be contained in different resin films.

The resin film can be formed by dissolving or dispersing a dye, a resin or a raw material component of the resin, and respective components blended as necessary in a solvent to prepare a coating solution, applying the coating solution to a support, drying the coating solution, and further curing the coating solution as necessary. The support in this case may be the phosphate glass used for the filter, or may be a peelable support used only when the resin film is to be formed. The solvent may be a dispersion medium capable of stably dispersing components or a solvent capable of dissolving components.

The coating solution may contain a surfactant in order to improve voids due to fine bubbles, depressions due to adhesion of foreign matters and the like, and repelling in a drying step. Further, for the application of the coating solution, for example, a dip coating method, a cast coating method, or a spin coating method can be used. The above coating solution is applied onto the support and then dried to form a resin film. When the coating solution contains a raw material component of the transparent resin, a curing process such as thermal curing or photocuring is further performed.

The resin film can also be manufactured into a film shape by extrusion molding. A substrate can be manufactured by laminating the obtained film-shaped resin film on the phosphate glass and integrating the resin film and the phosphate glass by thermal press fitting or the like.

The optical filter may have one layer of the resin film, or may have two or more layers of the resin film. When the optical filter has two or more layers of the resin film, respective layers may have the same configuration or different configurations.

A thickness of the resin film is 10 μum or less and preferably 5 μm or less from the viewpoint of in-plane thickness distribution and appearance quality in a substrate after coating, and is preferably 0.5 μm or more from the viewpoint of exhibiting desired spectral characteristics at an appropriate dye concentration. When the optical filter has two or more layers of the resin film, a total thickness of the respective resin films is preferably within the above range.

The filter may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have a high visible light transmittance and have light absorbing properties in a wide range of an infrared wavelength region exceeding 1,200 nm, and thus can be used in the case where shielding properties of infrared light are required.

For example, when the optical filter according to the present embodiment is used in an imaging device such as a digital still camera, an imaging device having excellent color reproducibility can be provided. Such an imaging device includes a solid state image sensor, an imaging lens, and the optical filter according to the present embodiment. The optical filter according to the present embodiment can be used, for example, by being disposed between the imaging lens and the solid state image sensor, or by being directly attached to the solid state image sensor, the imaging lens, or the like of the imaging device via an adhesive layer.

As described above, the present description discloses the following optical filter and the like.
[1] An optical filter including a dielectric multilayer film 1, a resin film, phosphate glass, and a dielectric multilayer film 2 in this order, in which
the resin film includes a resin and a near-infrared ray absorbing dye having a maximum absorption wavelength in 690 nm to 800 nm in the resin,
the resin film has a thickness of 10 μm or less, and
the optical filter satisfies all of the following spectral characteristics (i-1) to (i-8).
(i-1) An average transmittance T_{450-600(0deg)AVE} at a wavelength of 450 nm to 600 nm and an incident angle of 0 degrees is 88.5% or more.
(i-2) An absolute value of a difference between the average transmittance T_{450-600(0deg)AVE} and an average transmittance T_{450-600(60deg)AVE} at a wavelength of 450 nm to 600 nm and an incident angle of 60 degrees is 6% or less.
(i-3) In a wavelength of 450 nm to 600 nm, an absolute value of a difference between a transmittance at an incident angle of 0 degrees and a transmittance at an incident angle of 60 degrees is 8% or less at maximum.
(i-4) An average transmittance T_{600-700(0deg)AVE} at a wavelength of 600 nm to 700 nm and an incident angle of 0 degrees is 30% or more.
(i-5) An absolute value of a difference between the average transmittance T_{600-700(0deg)AVE} and an average transmittance T_{600-700(60deg)AVE} at a wavelength of 600 nm to 700 nm and an incident angle of 60 degrees is 10% or less.
(i-6) An average transmittance T_{750-1100(0deg)AVE} at a wavelength of 750 nm to 1,100 nm and an incident angle of 0 degrees is 0.5% or less.
(i-7) An absolute value of a difference between the average transmittance T_{750-1100(0deg)AVE} and an average transmittance T_{750-1100(60deg)AVE} at a wavelength of 750 nm to 1,100 nm and an incident angle of 60 degrees is 0.5% or less.
(i-8) In a wavelength of 750 nm to 1,100 nm, an absolute value of a difference between a transmittance at an incident angle of 0 degrees and a transmittance at an incident angle of 60 degrees is 0.7% or less at maximum.
[2] The optical filter according to [1], further satisfying the following spectral characteristics (i-9) and (i-10).
(i-9) In a wavelength of 450 nm to 600 nm, a difference between a maximum value and a minimum value of the absolute value of the difference between the transmittance at an incident angle of 0 degrees and the transmittance at an incident angle of 60 degrees is 6% or less.
(i-10) In a wavelength of 750 nm to 1,100 nm, a difference between a maximum value and a minimum value of the absolute value of the difference between the transmittance at an incident angle of 0 degrees and the transmittance at an incident angle of 60 degrees is 1% or less.
[3] The optical filter according to [1] or [2], further satisfying the following spectral characteristics (i-11) and (i-12).
(i-11) When a dielectric multilayer film 2 side is set as an incident direction, an average of an absorption loss amount₄₅₀₋₆₀₀ defined below in a wavelength of 450 nm to 600 nm is 10% or less:

$$( absorption loss {amount}_{450 - 600} ) [ \% ] = 100 - ( transmittance at incident angle of 5 degrees ) - ( reflectance at incident angle of 5 degrees ) .$$

(i-12) When a dielectric multilayer film 2 side is set as an incident direction, an average of an absorption loss amount₇₅₀₋₁₂₀₀ defined below in a wavelength of 750 nm to 1,200 nm is 60% or more:

$$( absorption loss {amount}_{750 - 1200} ) [ \% ] = 100 - ( transmittance at incident angle of 5 degrees ) - ( reflectance at incident angle of 5 degrees ) .$$

[4] The optical filter according to any of [1] to [3], further satisfying the following spectral characteristics (i-13) and (i-14).
(i-13) When a dielectric multilayer film 2 side is set as an incident direction, an average reflectance R2_{450-600(5deg)AVE} at a wavelength of 450 nm to 600 nm and an incident angle of 5 degrees is 2% or less.
(i-14) When a dielectric multilayer film 2 side is set as an incident direction, an average reflectance R2_{750-1200(5deg)AVE} at a wavelength of 750 nm to 1,200 nm and an incident angle of 5 degrees is 35% or less.
[5] The optical filter according to any of [1] to [4], in which
at least one of the dielectric multilayer film 1 and the dielectric multilayer film 2 includes one or more dielectric layers having a refractive index of 1.38 to 1.5 at a wavelength of 500 nm.
[6] The optical filter according to any of [1] to [5], in which
at least one of the dielectric multilayer film 1 and the dielectric multilayer film 2 includes one or more dielectric layers formed of MgF₂.
[7] The optical filter according to any of [1] to [6], in which each of the dielectric multilayer film 1 and the dielectric multilayer film 2 includes one or more dielectric layers formed of MgF₂.
[8] The optical filter according to any of [1] to [7], in which
at least one of the dielectric multilayer film 1 and the dielectric multilayer film 2 includes three or more dielectric layers having different refractive indices.
[9] The optical filter according to any of [1] to [8], in which
the phosphate glass satisfies all of the following spectral characteristics (ii-1) to (ii-5).
(ii-1) An internal transmittance T₄₅₀ at a wavelength of 450 nm is 92% or more.
(ii-2) An average internal transmittance T_{450-600AVE} at a wavelength of 450 nm to 600 nm is 90% or more.
(ii-3) IR50 at which an internal transmittance is 50% is in a wavelength range of 625 nm to 650 nm.
(ii-4) An average internal transmittance T_{750-1000AVE} at a wavelength of 750 nm to 1,000 nm is 2.5% or less.
(ii-5) An average internal transmittance T_{1000-1200AVE} at a wavelength of 1,000 nm to 1,200 nm is 7% or less.
The optical filter according to any of [1] to [9], in which
the near-infrared ray absorbing dye contains a squarylium dye, and
the resin film satisfies all of the following spectral characteristics (iii-1) to (iii-3).
(iii-1) An internal transmittance T₄₅₀ at a wavelength of 450 nm is 85% or more.
(iii-2) An average internal transmittance T_{450-600AVE} at a wavelength of 450 nm to 600 nm is 90% or more.
(iii-3) A wavelength IR50 at which an internal transmittance is 50% is in a range of 620 nm to 750 nm.
[11] An imaging device including the optical filter according to any of [1] to [10].

### EXAMPLES

Next, the present invention is described more specifically with reference to examples.

For measurement of each spectral characteristic, an ultraviolet-visible spectrophotometer (UH-4150 type, manufactured by Hitachi High-Tech Corporation) was used.

The spectral characteristic in the case where an incident angle is not particularly specified is a value measured at an incident angle of 0 degrees (in a direction perpendicular to a main surface of the optical filter).

Dyes used in respective examples are as follows.
Compound 1 (squarylium compound): synthesized based on WO2017/135359.
Compound 2 (cyanine compound): synthesized based on a method described in Dyes and Pigments, 73, 344 to 352 (2007).
Compound 3 (merocyanine compound): synthesized based on the description of German Patent No. 10109243.

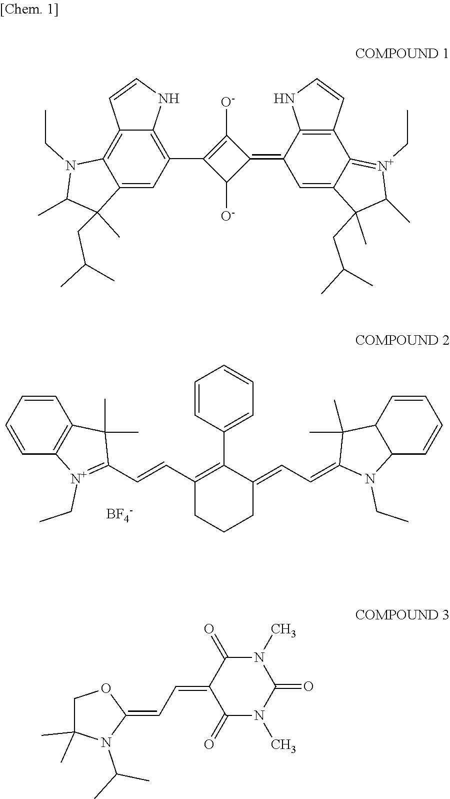

### Spectral Characteristics of Dye in Resin

A polyimide resin (“C3G30G” (trade name), manufactured by Mitsubishi Gas Chemical Company, Inc., refractive index: 1.59) was dissolved in a mixture of γ-butyrolactone (GBL):cyclohexanone=1:1 (mass ratio) to prepare a polyimide resin solution having a resin concentration of 8.5 mass %.
Each of the dyes of the above compounds 1 to 3 was added to the resin solution at a concentration of 7.5 parts by mass with respect to 100 parts by mass of the resin, and stirred and dissolved at 50° C. for 2 hours to obtain a coating solution. The obtained coating solution was applied to an alkaline glass (D263 glass, manufactured by SCHOTT, thickness: 0.2 mm) by a spin coating method to form a coating film having a thickness of about 1.0 μm.
With respect to the obtained coating film, a spectral transmittance curve in a wavelength range of 350 nm to 1,200 nm was measured using the ultraviolet-visible spectrophotometer.
The spectral characteristics in the polyimide resin of the above respective compounds 1 to 3 are shown in the following table. The spectral characteristics shown in the following table were evaluated in terms of internal transmittance in order to avoid an influence of reflection at an air interface and a glass interface.

TABLE 1

| | Maximum absorption |
|---|---|
| Dye number | wavelength in resin |
| Compound 1 | 752 nm |
| Compound 2 | 773 nm |
| Compound 3 | 400 nm |

### Spectral Characteristics of Phosphate Glass

As the near-infrared ray absorbing glass, a phosphate glass 1 and a phosphate glass 2 having compositions shown in Table 2 below were prepared.
Raw materials were weighed and mixed so as to have the compositions (mass % based on oxide) shown in Table 2 below, and the mixture was put into a crucible having an internal volume of about 400 cc and melted in an air atmosphere for 2 hours. Thereafter, the mixture was refined, stirred, and cast into a rectangular mold having a length of 100 mm, a width of 80 mm, and a height of 20 mm that was preheated to about 300° C. to 500° C., and then slowly cooled at about 1° C./min to obtain a plate-like glass having a length of 40 mm, a width of 30 mm, and a thickness of 0.292 mm, both surfaces of which were optically polished.

TABLE 2

| (mass %) | Phosphate glass 1 | Phosphate glass 2 |
|---|---|---|
| P₂O₅ | 68.73 | 68.53 |
| Al₂O₃ | 11.36 | 11.32 |
| Li₂O | 0.00 | 0.00 |
| Na₂O | 3.16 | 3.15 |
| K₂O | 9.06 | 9.04 |
| CaO | 0.00 | 0.00 |
| SrO | 0.00 | 0.00 |
| BaO | 0.00 | 0.00 |
| MoO₃ | 0.00 | 0.30 |
| CuO | 7.68 | 7.66 |
| F | 0.00 | 0.00 |
| Total | 100 | 100 |

With respect to the phosphate glass, a spectral transmittance curve in the wavelength range of 350 nm to 1,200 nm was measured using the ultraviolet-visible spectrophotometer.
The obtained spectral characteristics are shown in Table 3 below. The spectral characteristics shown in the following table were evaluated in terms of internal transmittance in order to avoid an influence of reflection at an air interface and a glass interface.
A spectral transmittance curve of the phosphate glass 2 is illustrated in FIG. 2.

TABLE 3

| | | Phosphate | Phosphate |
|---|---|---|---|
| Glass | Type | glass 1 | glass 2 |
| | Thickness (mm) | 0.292 | 0.292 |
| Spectral | 450 nm internal transmittance | 96.6 | 98.2 |
| characteristics | (%) | | |
| | 450-600 nm average internal | 93.9 | 94.1 |
| | transmittance (%) | | |
| | IR50 (nm) | 639 | 636 |
| | 750-1,000 nm average internal | 0.8 | 0.9 |
| | transmittance (%) | | |
| | 1,000-1,200 nm average internal | 2.0 | 2.1 |
| | transmittance (%) | | |

As described above, it is understood that the phosphate glass used has a high transmittance in the visible light region and is excellent in light-shielding properties in the near-infrared ray region.

### Example 1-1: Spectral Characteristics of Resin Film

The dyes of the compounds 1 to 3 were mixed with a polyimide resin solution prepared in the same manner as in calculation of the spectral characteristics of the above compounds at a concentration shown in Table 4 below, and stirred and dissolved at 50° C. for 2 hours to obtain a coating solution. The obtained coating solution was applied to an alkaline glass (D263 glass, manufactured by SCHOTT, thickness: 0.2 mm) by a spin coating method to form a resin film having a thickness of 3.0 μm.

With respect to the obtained resin film, a spectral transmittance curve in the wavelength range of 350 nm to 1,200 nm was measured using the ultraviolet-visible spectrophotometer.

The obtained results of the spectral characteristics are shown in the following table. The spectral characteristics shown in the following table were evaluated in terms of internal transmittance in order to avoid an influence of reflection at an air interface and a glass interface.

A spectral transmittance curve of the resin film of Example 1-1 is illustrated in FIG. 3.
Example 1-1 is a reference example.

TABLE 4

| | | Example 1-1 |
|---|---|---|
| Added amount | Compound 1 (λMAX: 752 nm) | 2.33 |
| of dye (mass %) | Compound 2 (λMAX: 773 nm) | 2.60 |
| | Compound 3 (λMAX: 400 nm) | 6.19 |
| | Total | 11.11 |
| Spectral | 450 nm internal transmittance (%) | 91.6 |
| characteristics of | 450-600 nm average internal | 96.2 |
| resin film | transmittance (%) | |
| | IR50 (nm) | 683 |

### Example 2-1: Spectral Characteristics of Optical Filter

A resin film was formed on one main surface of the phosphate glass 2 in the same manner as in Example 1-1. TiO₂, SiO₂, and MgF₂ were laminated on a surface of the resin film in an order and a thickness (nm) shown in Table 5 below by vapor deposition to form a dielectric multilayer film 1. TiO₂, SiO₂, and MgF₂ were laminated on the other main surface of the phosphate glass 2 in an order and a thickness shown in Table 5 below by vapor deposition to form a dielectric multilayer film 2.
In this manner, an optical filter having a configuration of dielectric multilayer film 2 (front surface)/phosphate glass/resin film/dielectric multilayer film 1 (rear surface) was prepared.

### Examples 2-2 to 2-6: Spectral Characteristics of Optical Filter

Optical filters were prepared in the same manner as in Example 2-1 except that the phosphate glass, the dielectric multilayer film 1, and the dielectric multilayer film 2 were changed to have configurations shown in Table 5 below.

TABLE 5

| Optical filter | | Example 2-1 | | Example 2-2 | | Example 2-3 | | Example 2-4 | | Example 2-5 | | Example 2-6 | |
|---|---|---|---|---|---|---|---|---|---|---|---|---|---|
| Dielectric | 20 | | | | | MgF₂ | 119.6 | | | | | | |
| multilayer | 19 | | | | | TiO₂ | 10.8 | | | | | | |
| film 1 | 18 | | | | | Al₂O₃ | 74.7 | | | | | | |
| | 17 | | | | | SiO₂ | 111.3 | | | | | | |
| | 16 | MgF₂ | 108.3 | | | Al₂O₃ | 62.3 | MgF₂ | 108.3 | SiO₂ | 97.6 | SiO₂ | 97.6 |
| | 15 | TiO₂ | 104.7 | MgF₂ | 107.9 | TiO₂ | 31.2 | TiO₂ | 104.7 | TiO₂ | 69.4 | TiO₂ | 69.4 |
| | 14 | SiO₂ | 17.6 | TiO₂ | 99.3 | Al₂O₃ | 41.5 | SiO₂ | 17.6 | SiO₂ | 23.7 | SiO₂ | 23.7 |
| | 13 | TiO₂ | 12.3 | SiO₂ | 14.0 | TiO₂ | 16.0 | TiO₂ | 12.3 | TiO₂ | 21.2 | TiO₂ | 21.2 |
| | 12 | SiO₂ | 43.7 | TiO₂ | 15.2 | SiO₂ | 120.1 | SiO₂ | 43.7 | SiO₂ | 104.6 | SiO₂ | 104.6 |
| | 11 | TiO₂ | 26.4 | SiO₂ | 48.4 | Al₂O₃ | 25.8 | TiO₂ | 26.4 | TiO₂ | 22.4 | TiO₂ | 22.4 |
| | 10 | SiO₂ | 22.3 | TiO₂ | 23.3 | TiO₂ | 19.7 | SiO₂ | 22.3 | SiO₂ | 34.5 | SiO₂ | 34.5 |
| | 9 | TiO₂ | 82.4 | SiO₂ | 22.5 | SiO₂ | 28.5 | TiO₂ | 82.4 | TiO₂ | 60.0 | TiO₂ | 60.0 |
| | 8 | SiO₂ | 35.6 | TiO₂ | 100.9 | TiO₂ | 40.2 | SiO₂ | 35.6 | SiO₂ | 38.6 | SiO₂ | 38.6 |
| | 7 | TiO₂ | 23.7 | SiO₂ | 32.2 | SiO₂ | 6.0 | TiO₂ | 23.7 | TiO₂ | 32.8 | TiO₂ | 32.8 |
| | 6 | SiO₂ | 68.3 | TiO₂ | 30.9 | Al₂O₃ | 173.6 | SiO₂ | 68.3 | SiO₂ | 45.6 | SiO₂ | 45.6 |
| | 5 | TiO₂ | 25.1 | SiO₂ | 50.0 | TiO₂ | 23.2 | TiO₂ | 25.1 | TiO₂ | 48.6 | TiO₂ | 48.6 |
| | 4 | SiO₂ | 48.8 | TiO₂ | 30.7 | Al₂O₃ | 36.3 | SiO₂ | 48.8 | SiO₂ | 28.2 | SiO₂ | 28.2 |
| | 3 | TiO₂ | 23.8 | SiO₂ | 53.5 | TiO₂ | 15.2 | TiO₂ | 23.8 | TiO₂ | 34.0 | TiO₂ | 34.0 |
| | 2 | SiO₂ | 49.9 | TiO₂ | 16.6 | Al₂O₃ | 91.5 | SiO₂ | 49.9 | SiO₂ | 48.7 | SiO₂ | 48.7 |
| | 1 | TiO₂ | 8.4 | MgF₂ | 19.5 | MgF₂ | 15.7 | TiO₂ | 8.4 | TiO₂ | 9.1 | TiO₂ | 9.1 |

| | | Resin film | | | | | | | | | | | |
|---|---|---|---|---|---|---|---|---|---|---|---|---|---|
| | | Resin film 1-1 | | Resin film 1-1 | | Resin film 1-1 | | Resin film 1-1 | | Resin film 1-1 | | Resin film 1-1 | |
| | | Glass | | | | | | | | | | | |
| | | Phosphate | | Phosphate | | Phosphate | | Phosphate | | Phosphate | | Phosphate | |
| | | glass 2 | | glass 2 | | glass 2 | | glass 1 | | glass 2 | | glass 1 | |
| Dielectric | 1 | TiO₂ | 6.5 | MgF₂ | 18.2 | MgF₂ | 14.3 | TiO₂ | 6.5 | TiO₂ | 8.3 | TiO₂ | 8.3 |
| multilayer | 2 | SiO₂ | 61.9 | TiO₂ | 14.2 | Al₂O₃ | 82.3 | SiO₂ | 61.9 | SiO₂ | 55.2 | SiO₂ | 55.2 |
| film 2 | 3 | TiO₂ | 23.3 | SiO₂ | 57.3 | TiO₂ | 16.8 | TiO₂ | 23.3 | TiO₂ | 33.8 | TiO₂ | 33.8 |
| | 4 | SiO₂ | 49.3 | TiO₂ | 30.1 | Al₂O₃ | 33.1 | SiO₂ | 49.3 | SiO₂ | 25.8 | SiO₂ | 25.8 |
| | 5 | TiO₂ | 29.8 | SiO₂ | 48.3 | TiO₂ | 24.6 | TiO₂ | 29.8 | TiO₂ | 53.2 | TiO₂ | 53.2 |
| | 6 | SiO₂ | 63.6 | TiO₂ | 32.5 | Al₂O₃ | 170.9 | SiO₂ | 63.6 | SiO₂ | 43.4 | SiO₂ | 43.4 |
| | 7 | TiO₂ | 25.8 | SiO₂ | 30.2 | SiO₂ | 6.0 | TiO₂ | 25.8 | TiO₂ | 32.8 | TiO₂ | 32.8 |
| | 8 | SiO₂ | 37.5 | TiO₂ | 98.9 | TiO₂ | 40.3 | SiO₂ | 37.5 | SiO₂ | 38.5 | SiO₂ | 38.5 |
| | 9 | TiO₂ | 83.0 | SiO₂ | 22.2 | SiO₂ | 28.3 | TiO₂ | 83.0 | TiO₂ | 62.3 | TiO₂ | 62.3 |
| | 10 | SiO₂ | 20.7 | TiO₂ | 24.2 | TiO₂ | 19.5 | SiO₂ | 20.7 | SiO₂ | 32.7 | SiO₂ | 32.7 |
| | 11 | TiO₂ | 27.8 | SiO₂ | 49.8 | Al₂O₃ | 25.8 | TiO₂ | 27.8 | TiO₂ | 23.0 | TiO₂ | 23.0 |
| | 12 | SiO₂ | 46.7 | TiO₂ | 15.9 | SiO₂ | 119.7 | SiO₂ | 46.7 | SiO₂ | 103.4 | SiO₂ | 103.4 |
| | 13 | TiO₂ | 14.4 | SiO₂ | 14.2 | TiO₂ | 16.3 | TiO₂ | 14.4 | TiO₂ | 21.1 | TiO₂ | 21.1 |
| | 14 | SiO₂ | 17.2 | TiO₂ | 98.7 | Al₂O₃ | 40.8 | SiO₂ | 17.2 | SiO₂ | 23.9 | SiO₂ | 23.9 |
| | 15 | TiO₂ | 103.0 | MgF₂ | 107.9 | TiO₂ | 31.6 | TiO₂ | 103.0 | TiO₂ | 69.5 | TiO₂ | 69.5 |
| | 16 | MgF₂ | 108.7 | | | Al₂O₃ | 62.3 | MgF₂ | 108.7 | SiO₂ | 97.6 | SiO₂ | 97.6 |
| | 17 | | | | | SiO₂ | 110.5 | | | | | | |
| | 18 | | | | | Al₂O₃ | 74.9 | | | | | | |
| | 19 | | | | | TiO₂ | 10.8 | | | | | | |
| | 20 | | | | | MgF₂ | 119.5 | | | | | | |

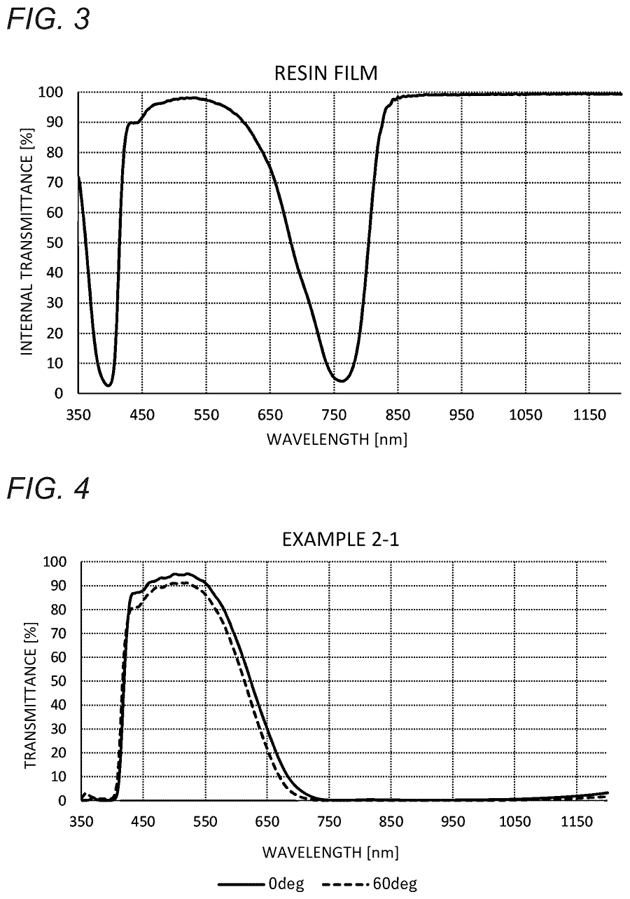

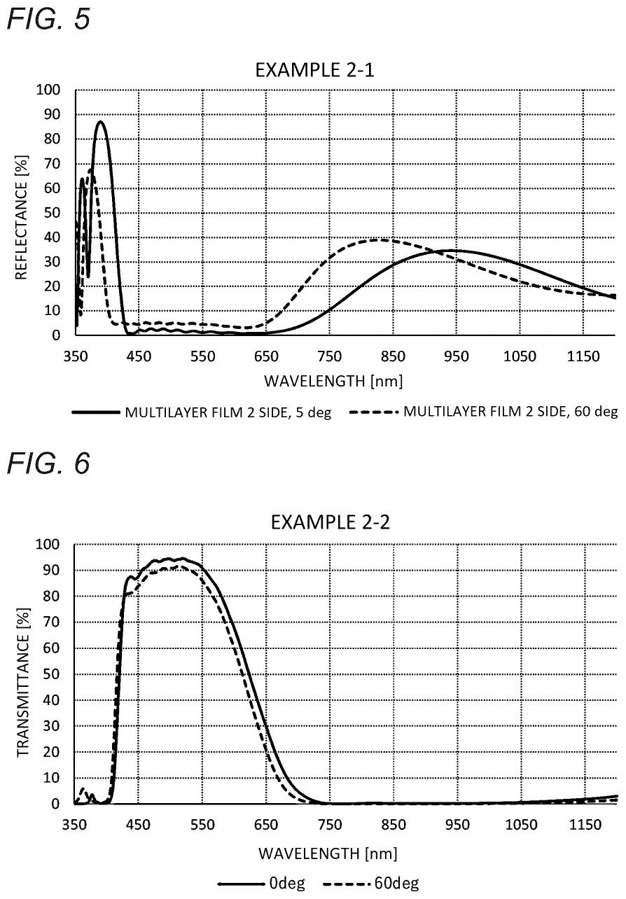

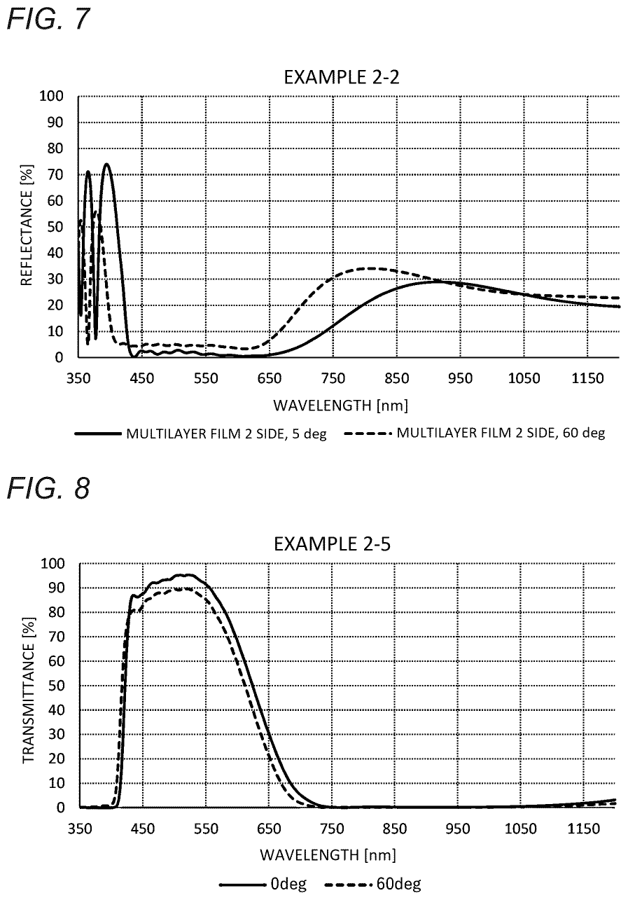

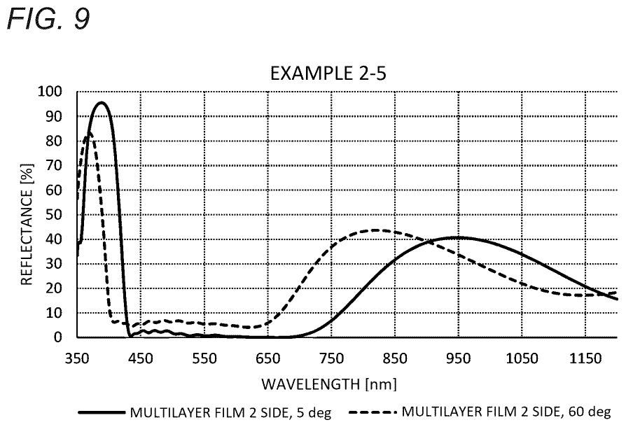

With respect to each of the optical filters, spectral transmittance curves at an incident angle of 0 degrees and an incident angle of 60 degrees and a spectral reflectance curve at an incident angle of 5 degrees in the wavelength range of 350 nm to 1,200 nm were measured using the ultraviolet-visible spectrophotometer.
Results are shown in the following table.
Spectral transmittance curves and spectral reflectance curves of the optical filter of Example 2-1 are illustrated in FIG. 4 and FIG. 5, respectively. Spectral transmittance curves and spectral reflectance curves of the optical filter of Example 2-2 are illustrated in FIG. 6 and FIG. 7, respectively. Spectral transmittance curves and spectral reflectance curves of the optical filter of Example 2-5 are illustrated in FIG. 8 and FIG. 9, respectively.
Examples 2-1 to 2-4 are inventive examples, and Examples 2-5 and 2-6 are comparative examples.

TABLE 6

| | Example | Example | Example | Example | Example | Example |
|---|---|---|---|---|---|---|
| Optical filter | 2-1 | 2-2 | 2-3 | 2-4 | 2-5 | 2-6 |
| 450-600 nm, 0 deg, average transmittance (%) | 89.0 | 89.0 | 90.0 | 88.8 | 89.3 | 89.1 |
| 450-600 nm, absolute value of difference between average | 4.5 | 4.5 | 5.1 | 4.6 | 6.2 | 6.2 |
| transmittance at 0 deg and average transmittance at 60 deg | | | | | | |
| [%] | | | | | | |
| 450-600 nm, maximum value of absolute value of difference | 7.3 | 7.7 | 7.3 | 7.1 | 9.1 | 9.0 |
| between transmittance at 0 deg and transmittance at 60 deg | | | | | | |
| (%) | | | | | | |
| 600-700 nm, 0 deg, average transmittance (%) | 32.0 | 32.0 | 32.4 | 33.0 | 32.4 | 33.6 |
| 600-700 nm, absolute value of difference between average | 7.1 | 7.5 | 9.4 | 7.2 | 8.0 | 8.2 |
| transmittance at 0 deg and average transmittance at 60 deg | | | | | | |
| (%) | | | | | | |
| 750-1,100 nm, 0 deg, average transmittance (%) | 0.3 | 0.4 | 0.3 | 0.3 | 0.3 | 0.3 |
| 750-1,100 nm, absolute value of difference between average | 0.2 | 0.2 | 0.1 | 0.2 | 0.2 | 0.2 |
| transmittance at 0 deg and average transmittance at 60 deg | | | | | | |
| (%) | | | | | | |
| 750-1,100 nm, maximum value of absolute value of | 0.5 | 0.6 | 0.5 | 0.5 | 0.4 | 0.4 |
| difference between transmittance at 0 deg and transmittance | | | | | | |
| at 60 deg (%) | | | | | | |
| 450-600 nm, difference between maximum value and | 4.4 | 5.1 | 3.6 | 4.1 | 5.0 | 4.7 |
| minimum value of absolute value of difference between | | | | | | |
| transmittance at 0 deg and transmittance at 60 deg (%) | | | | | | |
| 750-1,100 nm, difference between maximum value and | 0.5 | 0.6 | 0.5 | 0.4 | 0.4 | 0.3 |
| minimum value of absolute value of difference between | | | | | | |
| transmittance at 0 deg and transmittance at 60 deg (%) | | | | | | |
| 450-600 nm, average value of absorption loss amount (%) | 9.3 | 9.4 | 9.3 | 9.5 | 9.3 | 9.5 |
| 750-1,200 nm, average value of absorption loss amount (%) | 71.6 | 74.9 | 60.2 | 71.7 | 68.1 | 68.1 |
| 450-600 nm, 5 deg, average reflectance on multilayer film 2 | 1.6 | 1.6 | 0.7 | 1.6 | 1.4 | 1.4 |
| side (%) | | | | | | |
| 750-1,200 nm, 5 deg, average reflectance on multilayer film | 26.1 | 23.8 | 32.4 | 26.1 | 29.3 | 29.3 |
| 2 side (%) | | | | | | |

Based on the above results, it is understood that the optical filters of Examples 2-1 to 2-4 are filters having a high transmittance in the visible light region and high shielding properties in the near-infrared region extending over a wide range of 750 nm to 1,200 nm and in which the ripple generation is prevented since a change in transmittance of the visible light is low even at a high incident angle.
On the other hand, in the optical filters of Examples 2-5 and 2-6, a difference between an average transmittance at 0 degrees and an average transmittance at 60 degrees in the visible light region is large, that is, the change in transmittance of the visible light is large at a high incident angle. It is considered that since the dielectric multilayer films used in Examples 2-5 and 2-6 have high reflection characteristics, a ripple is likely to be generated in the visible light region at a high incident angle.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-138364) filed on Aug. 31, 2022, the content of which is incorporated herein by reference.

### INDUSTRIAL APPLICABILITY

The optical filter according to the present embodiment has spectral characteristics in which a ripple in the visible light region is prevented even at a high incident angle, and the transmittance in the visible light region and the shielding properties in the near-infrared light region are excellent. In recent years, the optical filter is useful for applications of imaging devices such as cameras and sensors for transport machines, for which high performance has been achieved.

### REFERENCE SIGNS LIST

1: optical filter
A1: dielectric multilayer film
A2: dielectric multilayer film
11: phosphate glass
12: resin film

1. An optical filter comprising a dielectric multilayer film 1, a resin film, a phosphate glass, and a dielectric multilayer film 2 in this order,
wherein the resin film comprises a resin and a near-infrared ray absorbing dye having a maximum absorption wavelength in 690 nm to 800 nm in the resin,
the resin film has a thickness of 10 μm or less, and
the optical filter satisfies all of the following spectral characteristics (i-1) to (i-8):
(i-1) an average transmittance T_{450-600(0deg)AVE} at a wavelength of 450 nm to 600 nm and an incident angle of 0 degrees is 88.5% or more
(i-2) an absolute value of a difference between the average transmittance T_{450-600(0deg)AVE} and an average transmittance T_{450-600(60deg)AVE} at a wavelength of 450 nm to 600 nm and an incident angle of 60 degrees is 6% or less
(i-3) in a wavelength of 450 nm to 600 nm, an absolute value of a difference between a transmittance at an incident angle of 0 degrees and a transmittance at an incident angle of 60 degrees is 8% or less at maximum
(i-4) an average transmittance T_{600-700(0deg)AVE} at a wavelength of 600 nm to 700 nm and an incident angle of 0 degrees is 30% or more
(i-5) an absolute value of a difference between the average transmittance T_{600-700(0deg)AVE} and an average transmittance T_{600-700(60deg)AVE} at a wavelength of 600 nm to ₇₀₀ nm and an incident angle of 60 degrees is 10% or less
(i-6) an average transmittance T_{750-1100(0deg)AVE} at a wavelength of 750 nm to 1,100 nm and an incident angle of 0 degrees is 0.5% or less
(i-7) an absolute value of a difference between the average transmittance T_{750-1100(0deg)AVE} and an average transmittance T_{750-1100(60deg)AVE} at a wavelength of 750 nm to 1,100 nm and an incident angle of 60 degrees is 0.5% or less
(i-8) in a wavelength of 750 nm to 1,100 nm, an absolute value of a difference between a transmittance at an incident angle of 0 degrees and a transmittance at an incident angle of 60 degrees is 0.7% or less at maximum.

2. The optical filter according to claim 1, further satisfying the following spectral characteristics (i-9) and (i-10):
(i-9) in a wavelength of 450 nm to 600 nm, a difference between a maximum value and a minimum value of the absolute value of the difference between the transmittance at an incident angle of 0 degrees and the transmittance at an incident angle of 60 degrees is 6% or less
(i-10) in a wavelength of 750 nm to 1,100 nm, a difference between a maximum value and a minimum value of the absolute value of the difference between the transmittance at an incident angle of 0 degrees and the transmittance at an incident angle of 60 degrees is 1% or less.

3. The optical filter according to claim 1, further satisfying the following spectral characteristics (i-11) and (i-12):
(i-11) when a dielectric multilayer film 2 side is set as an incident direction, an average of an absorption loss amount₄₅₀₋₆₀₀ defined below in a wavelength of 450 nm to 600 nm is 10% or less:
$$( absorption loss {amount}_{450 - 600} ) [ \% ] = 100 - ( transmittance at incident angle of 5 degrees ) - ( reflectance at incident angle of 5 degrees ) .$$
(i-12) when a dielectric multilayer film 2 side is set as an incident direction, an average of an absorption loss amount₇₅₀₋₁₂₀₀ defined below in a wavelength of 750 nm to 1,200 nm is 60% or more:
$$( absorption loss {amount}_{750 - 1200} ) [ \% ] = 100 - ( transmittance at incident angle of 5 degrees ) - ( reflectance at incident angle of 5 degrees ) .$$

4. The optical filter according to claim 1, further satisfying the following spectral characteristics (i-13) and (i-14):
(i-13) when a dielectric multilayer film 2 side is set as an incident direction, an average reflectance R2_{450-600(5deg)AVE} at a wavelength of 450 nm to 600 nm and an incident angle of 5 degrees is 2% or less
(i-14) when a dielectric multilayer film 2 side is set as an incident direction, an average reflectance R2_{750-1200(5deg)AVE} at a wavelength of 750 nm to 1,200 nm and an incident angle of 5 degrees is 35% or less.

5. The optical filter according to claim 1,
wherein at least one of the dielectric multilayer film 1 and the dielectric multilayer film 2 comprises one or more dielectric layers having a refractive index of 1.38 to 1.5 at a wavelength of 500 nm.

6. The optical filter according to claim 1,
wherein at least one of the dielectric multilayer film 1 and the dielectric multilayer film 2 comprises one or more dielectric layers formed of MgF₂.

7. The optical filter according to claim 1,
wherein each of the dielectric multilayer film 1 and the dielectric multilayer film 2 comprises one or more dielectric layers formed of MgF₂.

8. The optical filter according to claim 1,
wherein at least one of the dielectric multilayer film 1 and the dielectric multilayer film 2 comprises three or more dielectric layers having different refractive indices.

9. The optical filter according to claim 1,
wherein the phosphate glass satisfies all of the following spectral characteristics (ii-1) to (ii-5):
(ii-1) an internal transmittance T₄₅₀ at a wavelength of 450 nm is 92% or more
(ii-2) an average internal transmittance T_{450-600AVE} at a wavelength of 450 nm to 600 nm is 90% or more
(ii-3) IR50 at which an internal transmittance is 50% is in a wavelength range of 625 nm to 650 nm
(ii-4) an average internal transmittance T_{750-1000AVE} at a wavelength of 750 nm to 1,000 nm is 2.5% or less
(ii-5) an average internal transmittance T_{1000-1200AVE} at a wavelength of 1,000 nm to 1,200 nm is 7% or less.

10. The optical filter according to claim 1,
wherein the near-infrared ray absorbing dye comprises a squarylium dye, and
the resin film satisfies all of the following spectral characteristics (iii-1) to (iii-3):
(iii-1) an internal transmittance T₄₅₀ at a wavelength of 450 nm is 85% or more
(iii-2) an average internal transmittance T_{450-600AVE} at a wavelength of 450 nm to 600 nm is 90% or more,
(iii-3) a wavelength IR50 at which an internal transmittance is 50% is in a range of 620 nm to 750 nm.

11. An imaging device comprising the optical filter according to claim 1.
